(19) United States
(12) Patent Application Publication
(10) Pub. No.: US 2015/0275560 A1
(43) Pub. Date: Oct. 1, 2015

(54) WINDOW REGULATOR, WINDOW REGULATOR SUBASSEMBLY AND METHOD OF ASSEMBLING THE SAME

(71) Applicant: SHIROKI CORPORATION, Fujisawa-shi, Kanagawa (JP)

(72) Inventors: Kenji Yamamoto, Kanagawa (JP); Yousuke Tsuchimoto, Kanagawa (JP)

(73) Assignee: SHIROKI CORPORATION, Kanagawa (JP)

(21) Appl. No.: 14/438,247

(22) PCT Filed: Oct. 9, 2013
(86) PCT No.: PCT/JP2013/077450

§ 371 Date: Apr. 24, 2015

(30) Foreign Application Priority Data
Oct. 29, 2012 (JP) 2012-237820
Oct. 29, 2012 (JP) 2012-237821

(51) Int. Cl. E05F 11/48; E05F 11/38; B60J 1/17; E05F 15/00; B60J 1/00

(52) U.S. Cl. CPC E05F 11/485; E05F 15/00; B60J 1/004; B60J 1/17; E05F 11/382

(57) ABSTRACT

A window regulator is obtained which can securely prevent a pulley body(s) from coming off a plastic panel when being delivered (when being carried), before the window regulator is installed onto a vehicle door.

A fit-in recessed portion 20a, into which a pulley assembly 30a is fitted, is formed on a plastic panel 10. Retaining projections 22 and 23 that extend from the peripheral edge of the fit-in recessed portion 20a toward a central part thereof and overlap the pulley body 31 of the pulley assembly 30a, which is fitted into the fit-in recessed portion 20a, in a plan view to prevent the pulley body 31 from coming out of the fit-in recessed portion 20a are formed on the plastic panel 10.

### TECHNICAL FIELD

The present invention relates to a window regulator for a vehicle door, and also relates to a window regulator subassembly that is prepared before being fixed to a vehicle door, and a method of assembling the window regulator subassembly.

### BACKGROUND ART

In recent years, a window regulator in which a plastic panel, with integrally-formed guide rails, is fixed inside a vehicle door has been adopted instead of a window regulator in which metal guide rails are fixed inside a vehicle door. Pulleys are supported on the plastic panel in advance at upper and lower parts of the guide rails, and wires which are connected to slider bases, which are supported on the guide rails to be upwardly and downwardly movable, are wound around a drive drum (winding drum) via the pulleys to achieve a window regulator subassembly, which enables a reduction in the number of components, reduces the weight and enhances the strength of the window regulator. When the window regulator subassembly is fixed to a vehicle door, the plastic panel is joined to a door panel (inner panel) via joining bolts which are inserted into shaft holes of the pulleys, and a window glass is joined onto the slider bases.

In a window regulator equipped with such a plastic panel, the pulleys that are supported by the plastic panel are usually designed as pulley assemblies in which pulley bodies are rotatably supported on pulley brackets in order to eliminate friction with the plastic panel, so that the rotatable reliability of the pulleys can be ensured.

Patent Literature 1 discloses, as a structure which supports the pulley assemblies to the plastic panel, the forming of fit-in recessed portions and engaging portions (latch connections) on the plastic panel, wherein the fit-in recessed portions are for fitting the pulley assemblies in upper and lower portions of the guide rails and the engaging portions are engaged with the pulley brackets at portions of the peripheral edges of the fit-in recessed portions.

### CITATION LIST

### Patent Literature

Patent Literature 1: a brochure of International Publication 2011/095414

### SUMMARY OF THE INVENTION

### Technical Problem

However, in the structure disclosed in Patent Literature 1, when being delivered (when being carried) before the plastic panel is installed onto a vehicle door, there is a possibility of tensile loads of the wires on the pulley bodies or an unexpected impact on the pulley assemblies causing the engagement between the pulley brackets of the pulley assemblies and the plastic panel to be released, thus causing the pulley bodies to come off the plastic panel.

On the other hand, in the window regulator equipped with the plastic panel, when the window regulator subassembly is assembled, the pulley assemblies need to be supported on the plastic assembly with tensile loads of the wires imposed on the pulley bodies. Therefore, if it is attempted to support the pulley assemblies on the plastic panel at random with no consideration given to the tensile loads of the wires on the pulley bodies, there is a possibility of problems occurring, such as the wires wound around the pulley bodies coming off or the pulley assemblies (the pulley bodies) breaking.

The present invention has been completed based on the awareness of the above described problems, and an object of the present invention is to achieve a window regulator which can securely prevent the pulley bodies from coming off the plastic panel during delivery (when being carried in) before the window regulator is installed onto a vehicle door.

In addition, an object of the present invention is to provide a window regulator subassembly which can reliably prevent the wires wound around the pulley bodies from coming off or the pulley assemblies (the pulley bodies) from being damaged when the pulley assemblies are supported onto the plastic panel, and to provide a method of assembling such a window regulator subassembly.

### Solution to Problem

The window regulator according to the present invention includes a plastic panel with which a guide rail, extending in an upward and downward direction, is integrally formed; a slider base which is supported to be movable upwardly and downwardly along the guide rail of the plastic panel and to which a window glass is fixed; a wire which is fixed to the slider base; and a pulley assembly which is supported by at least one of upper and lower parts of the guide rail of the plastic panel to be rotatable, the pulley assembly including a pulley body, around which the wire that is fixed to the slider base is wound. A fit-in recessed portion, into which the pulley assembly is fitted, is formed on the plastic panel. A retaining projection is formed on the plastic panel, the retaining projection extending from a peripheral edge of the fit-in recessed portion toward a central part thereof and overlapping the pulley body of the pulley assembly, which is fitted into the fit-in recessed portion, in a plan view to prevent the pulley body from coming out of the fit-in recessed portion.

It is desirable for the retaining projection to include at least one rigid retaining projection and at least one resilient retaining projection, which is softer and more easily elastically-deformable than the rigid retaining projection, the rigid retaining projection and the resilient retaining projection being positioned to sandwich the pulley body of the pulley assembly, which is fitted into the fit-in recessed portion, in a plan view.

It is desirable for the pulley body to include a base-surface flange, a top-surface flange and a wire guide groove which is formed between the base-surface flange and the top-surface flange, wherein an end of the rigid retaining projection faces the top-surface flange of the pulley body, and an end of the resilient retaining projection is positioned in the wire guide groove.

It is desirable for the rigid retaining projection to be positioned in a wire winding area of the pulley body in a plan view, and for the resilient retaining projection to be positioned in a wire non-winding area of the pulley body in a plan view.

In an embodiment, a method of assembling a window regulator subassembly is provided, the method including a step of preparing a plastic panel, wherein a guide rail which extends in an upward and downward direction, a fit-in recessed portion which is positioned at at least one of upper and lower parts of the guide rail, and a pulley retaining projection which extends from a peripheral edge of the fit-in recessed portion toward a central part thereof in a plan view are formed integral with the plastic panel; a step of making the guide rail hold a slider base, to which a window glass is fixed, in a manner to allow the slider base to freely move up and down; and a step of fitting a pulley assembly into the fit-in recessed portion with a wire, which is fixed to the slider base, wound around a pulley body of the pulley assembly. The step of fitting the pulley assembly performs, in the following order, a first step of winding the wire around the pulley body of the pulley assembly less than one turn; a second step of tilting an axis of the pulley assembly relative to an axis of the fit-in recessed portion and fitting a portion of the pulley assembly that corresponds to a wire winding area of the pulley body into the fit-in recessed portion, which is positioned underneath the pulley retaining projection, to thereby cause the pulley retaining projection to overlap the pulley body of the pulley assembly, which is fitted into the fit-in recessed portion in a plan view, to prevent the pulley body from coming out of the fit-in recessed portion; and a third step of tilting the axis of the pulley assembly in a direction to make the axis of the pulley assembly coincide with the axis of the fit-in recessed portion, and fitting a portion of the pulley assembly which corresponds to a wire non-winding area of the pulley body into the fit-in recessed portion of the plastic panel.

It is desirable for a wire retaining projection which extends from the peripheral edge of the fit-in recessed portion toward the central part thereof to be formed on the plastic panel. In the second step, the axis of the pulley assembly is tilted relative to the axis of the fit-in recessed portion, and the portion of the pulley assembly which corresponds to the wire winding area of the pulley body is inserted into the fit-in recessed portion, which is positioned underneath the pulley retaining projection.

It is desirable for a resilient projection which extends from the peripheral edge of the fit-in recessed portion toward the central part thereof to be formed on the plastic panel. In the third step, the axis of the pulley assembly is tilted in a direction to coincide with the axis of the fit-in recessed portion, and the portion of the pulley assembly which corresponds to the wire non-winding area of the pulley body is fitted into the fit-in recessed portion while the resilient projection is being deformed.

It is desirable for the wire retaining projection to also serve as the pulley retaining projection, which extends from the peripheral edge of the fit-in recessed portion toward the central part thereof and overlaps the pulley body, of the pulley assembly fitted into the fit-in recessed portion, in a plan view to prevent the pulley body from coming out of the fit-in recessed portion.

In an embodiment, a window regulator subassembly is produced by performing a step of preparing a plastic panel, wherein a guide rail which extends in an upward and downward direction, a fit-in recessed portion which is positioned at at least one of upper and lower parts of the guide rail, and a pulley retaining projection which extends from a peripheral edge of the fit-in recessed portion toward a central part thereof in a plan view are formed integral with the plastic panel; a step of making the guide rail hold a slider base, to which a window glass is fixed, in a manner to allow the slider base to move upwardly and downwardly; and a step of fitting a pulley assembly into the fit-in recessed portion with a wire, which is fixed to the slider base, wound around a pulley body of the pulley assembly. The step of fitting the pulley assembly fit-in performs, in the following order, a first step of winding the wire around the pulley body of the pulley assembly less than one turn; a second step of tilting an axis of the pulley assembly relative to an axis of the fit-in recessed portion and fitting a portion of the pulley assembly that corresponds to a wire winding area of the pulley body into the fit-in recessed portion of the plastic panel; a third step of tilting the axis of the pulley assembly in a direction to make the axis of the pulley assembly coincide with the axis of the fit-in recessed portion, and fitting a portion of the pulley assembly which corresponds to a wire non-winding area of the pulley body into the fit-in recessed portion of the plastic panel; and a fourth step of making the pulley retaining projection overlap the pulley body of the pulley assembly, which is fitted into the fit-in recessed portion, to prevent the pulley body from coming out of the fit-in recessed portion.

### Advantageous Effects of the Invention

According to the invention claimed in claim 1, the retaining projection that is formed on the plastic panel directly holds the pulley body of the pulley assembly, and accordingly, the pulley body can be reliably prevented from coming out of (coming off) the fit-in recessed portion of the plastic panel.

According to the invention claimed in claim 2, the rigid retaining projection can improve the retaining capability of the pulley assembly, which includes the pulley body, and the resilient retaining projection can improve the ease of insertion of the pulley assembly into the fit-in recessed portion.

According to the invention claimed in claim 3, the capability of retaining the pulley assembly, which includes the pulley body, that is achieved by the rigid retaining projection and the ease of insertion of the pulley assembly into the fit-in recessed portion that is achieved by the resilient retaining projection can further be improved. In addition, the durability of the resilient retaining projection can be improved by setting the displacement of resilient deformation of the resilient retaining projection, when the pulley assembly (which includes the pulley body) is fitted into the fit-in recessed portion of the plastic panel, to a small value.

According to the invention claimed in claim 4, it is possible to make the rigid retaining projection have the capability of retaining the drive wire wound around the pulley body in addition to the rigid retaining projection having the capability of retaining the pulley assembly, which includes the pulley body.

According to the invention claimed in claim 5, a portion of the pulley assembly which corresponds to the wire winding area of the pulley body (specifically, the area thereof on which the tensile load of the drive wire is most imposed) is first fitted into the fit-in recessed portion, and thereafter, a portion of the pulley assembly which corresponds to the wire non-winding area of the pulley body is fitted into the fit-in recessed portion, and accordingly, the problem with the drive wire (wound around the pulley body) coming off even though the tensile load of the drive wire is imposed on the pulley body and the problem with the pulley assembly (the pulley body) being damaged can be reliably prevented from occurring. In addition, since the pulley retaining projection which is formed on the plastic panel directly holds the pulley body of the pulley assembly, the pulley body can be reliably prevented from coming out of (coming off) the fit-in recessed portion of the plastic panel even if the tensile load of the wire is imposed on the pulley body or an unexpected impact is exerted on the pulley assembly when delivering (when carrying) the window regulator subassembly.

According to the invention claimed in claim 6, the drive wire wound around pulley body can be reliably prevented from coming out of (coming off) the fit-in recessed portion even if the tensile load of the wire is imposed on the pulley body or an unexpected impact is exerted on the pulley assembly when delivering (when carrying) the window regulator subassembly.

According to the invention claimed in claim 7, the ease of insertion of the pulley assembly into the fit-in recessed portion can be improved.

According to the invention claimed in claim 8, the pulley assembly (which includes the pulley body) can be reliably prevented from coming out of the fit-in recessed portion of the plastic panel even if the tensile load of the wire is imposed on the pulley body or an unexpected impact is exerted on the pulley assembly when delivering (when carrying) the window regulator subassembly. In addition, since the wire retaining projection and the pulley retaining projection do not have to be formed independently, it is possible to simplify the production by simplifying the structure of the plastic panel.

According to the invention claimed in claim 9, since the pulley retaining projection that is formed on the plastic panel directly holds the pulley body of the pulley assembly, the pulley body can be reliably prevented from coming out of (coming off) the fit-in recessed portion of the plastic panel even if the tensile load of the wire is imposed on the pulley body or an unexpected impact is exerted on the pulley assembly when delivering (when carrying) the window regulator subassembly.

### BRIEF DESCRIPTION OF THE DRAWINGS

FIG. 1 is a diagram showing a window regulator according to the present invention, viewed from the vehicle exterior side;

FIG. 2 is a diagram showing the window regulator according to the present invention, viewed from the vehicle interior side;

FIG. 3 is a diagram showing the window regulator according to the present invention, viewed in the forward/rearward direction of the vehicle;

FIG. 4 is a cross sectional view taken along the IV-IV line shown in FIG. 1;

FIG. 5 is an enlarged plan view of a fit-in recessed portion of a plastic panel, showing the structure thereof;

FIG. 6 is an enlarged perspective view of the fit-in recessed portion of the plastic panel, showing the structure thereof; and

FIGS. 7(A) through 7(D) are drawings for illustrating a process of fitting a pulley assembly on which the tensile load of a drive wire is imposed into the fit-in recessed portion of the plastic panel.

### DESCRIPTION OF EMBODIMENT

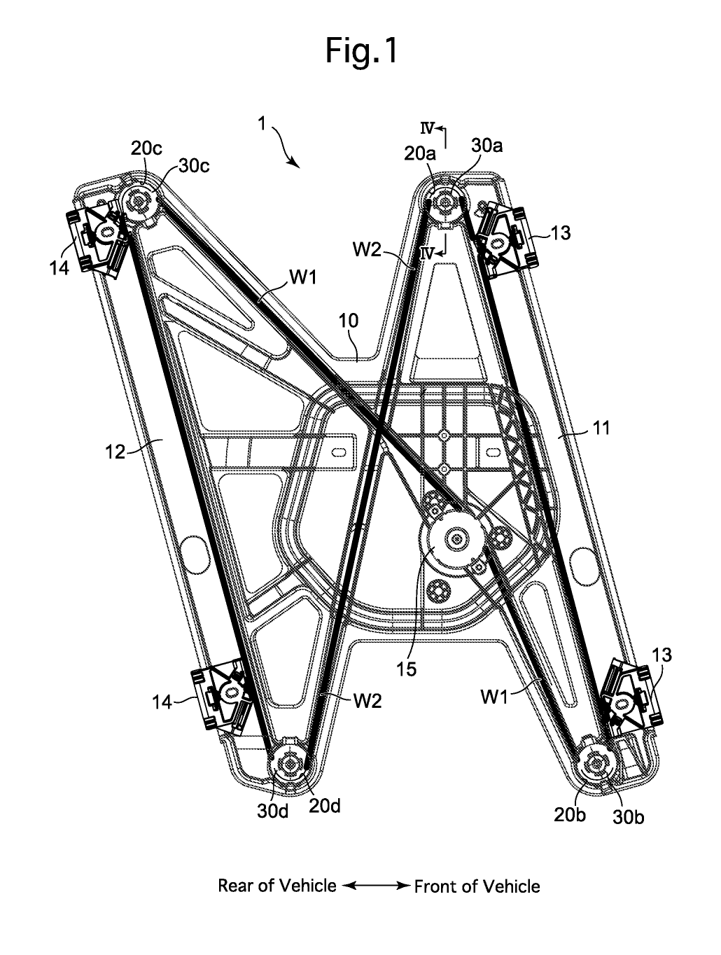

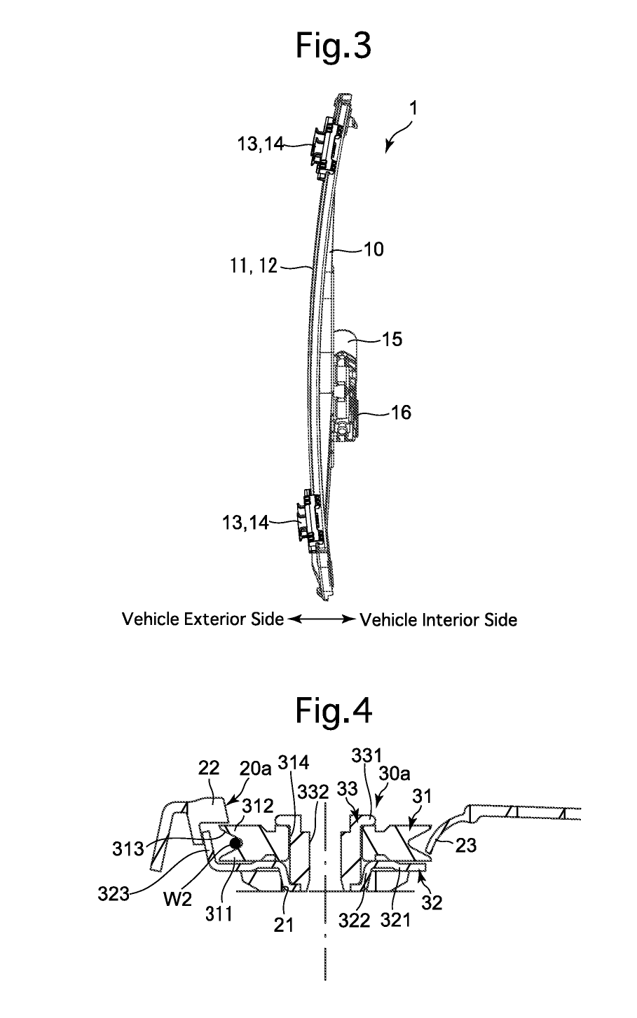

FIGS. 1 through 3 show the structure of a window regulator 1 according to the present invention. In these drawings, the window regulator 1 is illustrated in a subassembled state before it is installed in a vehicle door. Directions described in the following description are defined based on the directions of arrows shown in the drawings.

The window regulator 1 is provided with a unitarily-formed plastic (resin) panel 10 which is H-shaped, as viewed macroscopically in the widthwise direction of the vehicle (from the vehicle exterior side or the vehicle interior side), and which is slightly curved toward the vehicle exterior side from the vehicle interior side as viewed in the forward/rearward direction of the vehicle. The plastic panel 10 is integrally provided, on the vehicle-front side and the vehicle-rear side, with a straight guide rail 11 and a straight guide rail 12 which extend in the upward and downward direction. A slider base 13 and a slider base 14, to which a window glass (not shown) is fixed, are supported on the guide rail 11 and the guide rail 12 to be movable up and down.

Fit-in recessed portions 20a, 20b, 20c and 20d are integrally formed with the plastic panel 10 so that the fit-in recessed portions 20a and 20b are positioned at the upper and lower parts of the guide rail 11, respectively, and so that the fit-in recessed portions 20c and 20d are positioned at the upper and lower parts of the guide rail 12, respectively. Pulley assemblies (wire guide members) 30a, 30b, 30c and 30d are rotatably fitted into the fit-in recessed portions 20a, 20b, 20c and 20d, respectively. The fit-in recessed portions 20a through 20d are mutually identical in structure and the pulley assemblies 30a through 30d are mutually identical in structure.

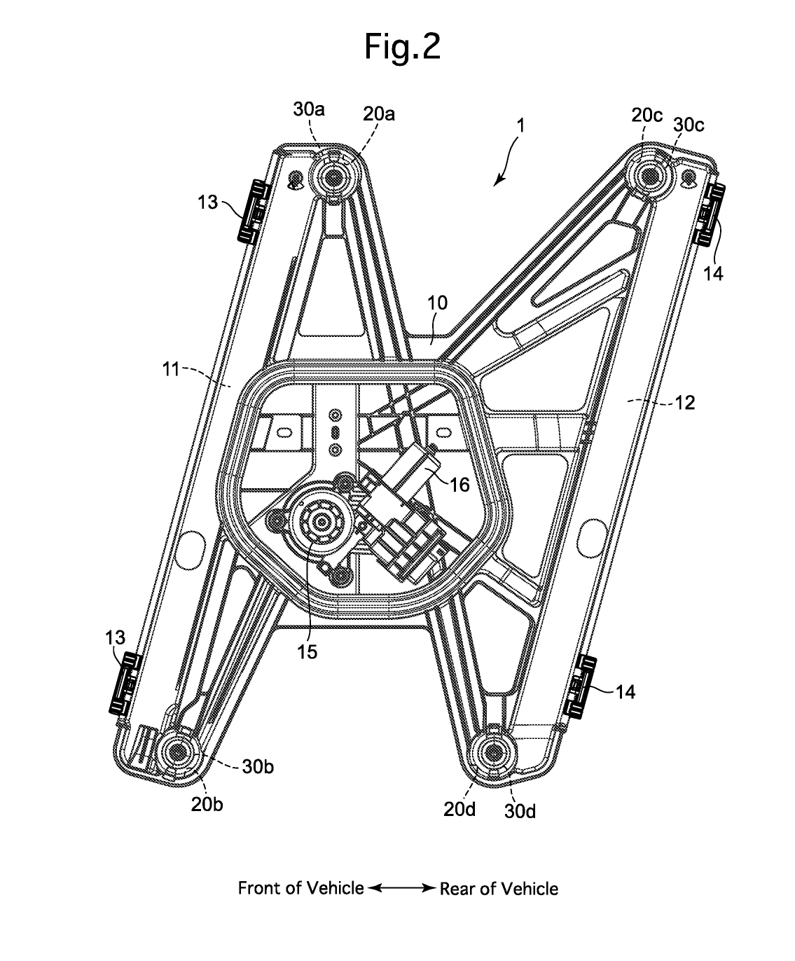

A drive drum 15 and a motor unit 16 which drives the drive drum 15 so that it rotates in the forward and reverse directions are supported on the plastic panel 10 at a central part thereof. A drive wire W1 is wound around the drive drum 15. The drive wire W1 is connected at one end thereof to the slider base 13 after changing direction via the pulley assembly 30b, while the drive wire W1 is connected at the other end thereof to the slider base 14 after changing direction via the pulley assembly 30c. In addition, the slider base 13 and the slider base 14 are connected to each other via a drive wire W2 (a separate member from the drive wire W1) which changes in direction by the pulley assemblies 30a and 30d thereat. Accordingly, driving the drive drum 15 by the motor unit 16 so that the drive drum 15 rotates forward and reverse causes the pair of slider bases 13 and 14 (the window glass) to move up and down while being guided by the pair of guide rails 11 and 12, respectively. In FIGS. 1 and 2, the top dead points of the slider bases 13 and 14, at which the window glass (not shown) is fully closed, and the bottom dead points of the slider bases 13 and 14, at which the window glass (not shown) is fully open, in a state where the window regulator 1 is incorporated in a vehicle door are both illustrated at the same time.

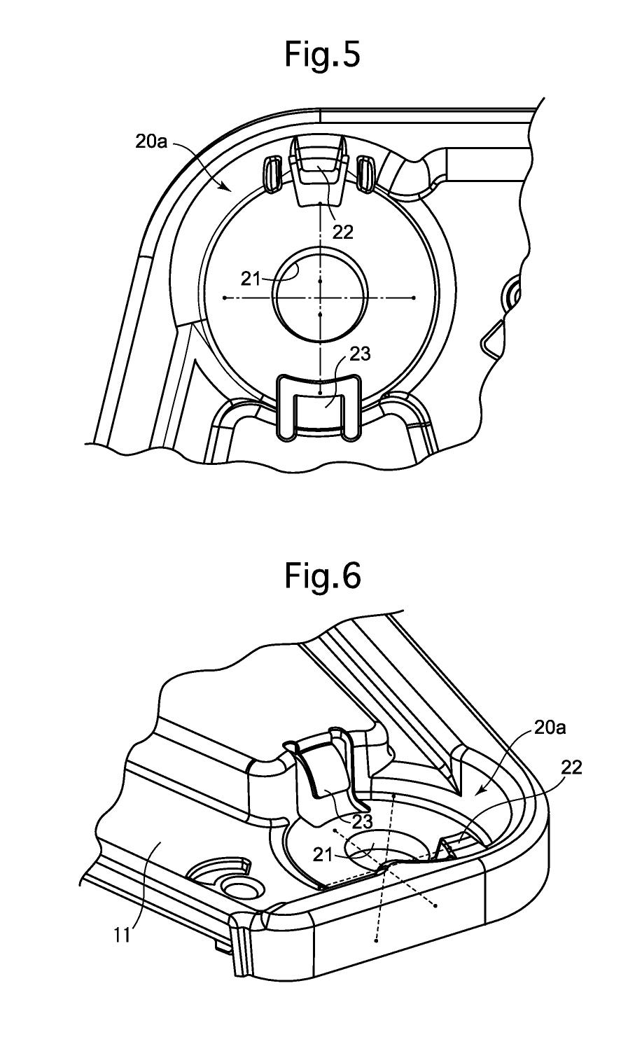

The structures of the fit-in recessed portion 20a, as a representative of the fit-in recessed portions 20a through 20d which are mutually identical in structure, and the pulley assembly 30a, as a representative of the pulley assemblies 30a through 30d which are mutually identical in structure, will be hereinafter discussed in detail with reference to FIGS. 4 through 6.

As shown in FIGS. 4 through 6, the fit-in recessed portion 20a is substantially circular in shape in a plan view, and a through-hole 21 is formed in a central part of the fit-in recessed portion 20a. A rigid retaining projection (retaining projection/wire retaining projection/pulley retaining projection) 22 and a resilient retaining projection (retaining projection/resilient projection) 23 are independently formed on the fit-in recessed portion 20a in a manner to sandwich the central through-hole 21 in a radial direction. The resilient retaining projection 23 is made of a material (e.g., leaf-spring material) which is more easily elastically-deformable and softer than that of the rigid retaining projection 22. Both the rigid retaining projection 22 and the resilient retaining projection 23 fall under the category of resilient members in a broad sense, and the terms “rigidity” and “resiliency” are herein used to indicate a criterion for relative rigidity between the two projections.

The rigid retaining projection 22 and the resilient retaining projection 23 are each formed on the peripheral edge of the fit-in recessed portion 20a into the shape of a cantilever, and extend from the peripheral edge of the fit-in recessed portion 20a toward a central part thereof so as to approach each other in a plan view. The rigid retaining projection 22 extends horizontally with respect to FIG. 4 from the peripheral edge of the fit-in recessed portion 20a toward a central part thereof, and the resilient retaining projection 23 has a circular arc shape (curved shape), extending from the peripheral edge of the fit-in recessed portion 20a toward a central part thereof so as to hang downward (in a bow-shaped manner) with respect to FIG. 4.

As shown in FIG. 4, the pulley assembly 30a is provided with a pulley body 31, a pulley bracket 32 and a nut member 33, which rotatably supports the pulley body 31 on the pulley bracket 32.

The pulley body 31 is provided with a base-surface flange 311 and a top-surface flange 312, each having a fully circular shape, and is further provided with a wire guide groove 313 which is formed between the base-surface flange 311 and the top-surface flange 312. A drive wire W2 which is fixed to the slider base 13 and the slider base 14 is wound around the wire guide groove 313. An insertion hole 314 for the nut member 33 to be inserted into is formed in a central part of the pulley body 31.

The pulley bracket 32 is provided with a pulley support surface 321 which supports the base-surface flange portion 311 of the pulley body 31, and a fit-in cylindrical portion 322 which extends downward with respect to FIG. 4 from a central part of the pulley support surface 321 to be fitted into the through-hole 21 of the fit-in recessed portion 20a. A raised wall portion 323 is formed on a portion of the pulley support surface 321 in the circumferential direction thereof and covers, in a plan view, the wire winding area of the pulley body 31 (the wire guide groove 313), specifically the area thereof on which the tensile load of the drive wire W2 is most imposed.

The nut member 33 is formed of a shaft member which is inserted into the insertion hole 314 of the pulley body 31 and fixed to the lower end with respect to FIG. 4 of the fit-in cylindrical portion 322 of the pulley bracket 32 by swaging. A flange 331 which is in contact with the top-surface flange 312 of the pulley body 31 is formed at the upper end of the nut member 33. A bolt insertion hole 332, into which a joining bolt (not shown) for incorporating the window regulator 1 in a subassembled state in a vehicle door is inserted, is formed in a central portion of the nut member 33.

In a state where the pulley assembly 30a is fitted into the fit-in recessed portion 20a that is structured as described above, the rigid retaining projection 22 and the resilient retaining projection 23 overlap the pulley body 31 so as to sandwich the pulley body 31 of the pulley assembly 30a in a plan view. The end of the rigid retaining projection 22 faces the top-surface flange 312 of the pulley body 31, while the end of the resilient retaining projection 23 is positioned in the wire guide groove 313 of the pulley body 31. Since the rigid retaining projection 22 and the resilient retaining projection 23 directly hold the pulley body 31 of the pulley assembly 30a as just described, the pulley body 31 can be reliably prevented from coming out of (coming off) the fit-in recessed portion 20a of the plastic panel 10. In addition, the rigid retaining projection 22 can improve the capability of retaining the pulley assembly 30a, which includes the pulley body 31, and the resilient retaining projection 23 can improve the ease of insertion of the pulley assembly 30a into the fit-in recessed portion 20a. Additionally, the durability of the resilient retaining projection 23 can be improved by setting the displacement of resilient deformation of the resilient retaining projection 23 to a small value when the pulley assembly 30a, which includes the pulley body 31, is fitted into the fit-in recessed portion 20a of the plastic panel 10.

The rigid retaining projection 22 is positioned on the farthest side from the drive drum 15 and the motor unit 16, and covers, in a plan view, the wire winding area of the pulley body 31 (the wire guide groove 313), specifically the area thereof on which the tensile load of the drive wire W2 is most imposed. This makes it possible to make the rigid retaining projection 22 also have the capability of retaining the drive wire W2 wound around the pulley body 31 in addition to the rigid retaining projection 22 having the capability of retaining the pulley assembly 30a, which includes the pulley body 31. The resilient retaining projection 23 is positioned on the closest side to the drive drum 15 and the motor unit 16 and covers, in a plan view, the wire non-winding area of the pulley body 31 (the wire guide groove 313), specifically the area thereof on which the tensile load of the drive wire W2 is not imposed.

The window regulator 1 that is constructed as described above is assembled in a manner which will be discussed hereinafter. First, the slider base 13 and the slider base 14 are supported onto the guide rail 11 and the guide rail 12 of the plastic panel 10 to be movable upwardly and downwardly. Subsequently, the drive wire W1 which is fixed at one end and the other end thereof to the slider base 13 and the slider base 14, respectively, and a middle part of which is wound around the drive drum 15 is wound around the pulley bodies 31 of the pulley assemblies 30b and 30c; and the pulley assembly 30b and the pulley assembly 30c, in a state where the tensile load of the drive wire W1 is imposed thereon, are fitted into the fit-in recessed portion 20b and the fit-in recessed portion 20c of the plastic panel 10, respectively. Simultaneously, the drive wire W2 which is fixed at one end and the other end thereof to the slider base 13 and the slider base 14, respectively, is wound around the pulley bodies 31 of the pulley assemblies 30a and 30d; and the pulley assembly 30a and the pulley assembly 30d, in a state where the tensile load of the drive wire W2 is imposed thereon, are fitted into the fit-in recessed portion 20a and the fit-in recessed portion 20d of the plastic panel 10, respectively.

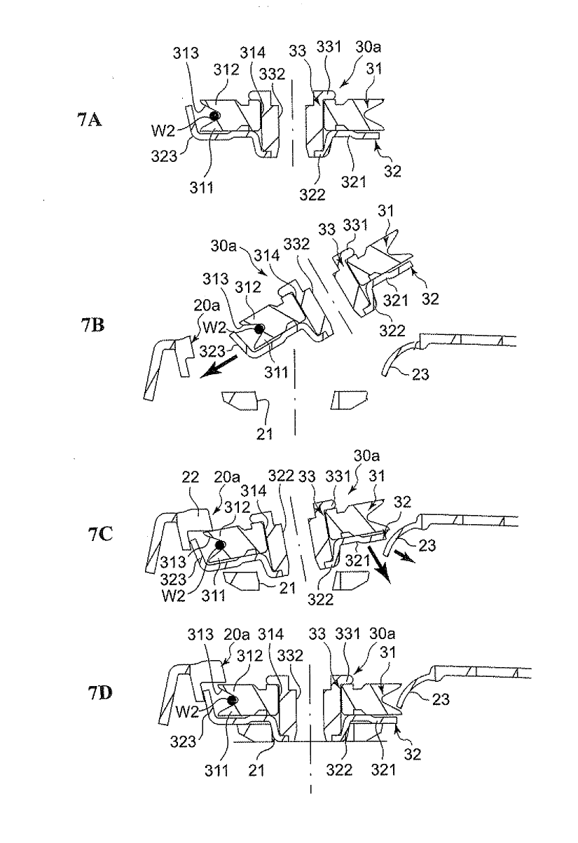

With reference to FIGS. 7(A) through 7(D), a process of fitting the pulley assembly 30a with the tensile load of the drive wire W2 imposed thereon into the fit-in recessed portion 20a of the plastic panel 10 will be hereinafter discussed in detail.

First, the drive wire W2 is wound around the wire guide groove 313 of the pulley body 31 of the pulley assembly 30a less than one turn as shown in FIG. 7(A) (first step).

Subsequently, as shown in FIG. 7(B), the axis of the pulley assembly 30a is made to tilt relative to the axis of the fit-in recessed portion 20a, and a portion of the pulley assembly 30a which corresponds to the wire winding area of the pulley body 31 is fitted into the fit-in recessed portion 20a (second step). More specifically, in a state where the inclination angle of the axis of the pulley assembly 30a relative to the axis of the fit-in recessed portion 20a is made maximum and where the circumferential position of the wire winding area of the pulley body 31 (specifically the area thereof on which the tensile load of the drive wire W2 is most imposed) and the circumferential position of the rigid retaining projection 22 are displaced from each other, the portion of the pulley assembly 30a which corresponds to the wire winding area of the pulley body 31 is fitted into the fit-in recessed portion 20a, and thereafter the circumferential position of the wire winding area of the pulley body 31 (specifically the area thereof on which the tensile load of the drive wire W2 is most imposed) and the circumferential position of the rigid retaining projection 22 are brought to coincide with each other while gradually reducing the inclination angle of the axis of the pulley assembly 30a relative to the axis of the fit-in recessed portion 20a. This causes the portion of the pulley assembly 30a that corresponds to the wire winding area of the pulley body 31 to be fitted into the fit-in recessed portion 20a that is positioned underneath the rigid retaining projection 22.

Subsequently, as shown in FIG. 7(C), the axis of the pulley assembly 30a is made to tilt in a direction to coincide with the axis of the fit-in recessed portion 20a, and a portion of the pulley assembly 30a which corresponds to the wire non-winding area of the pulley body 31 is fitted into the fit-in recessed portion 20a (third step). At this time, the resilient retaining projection 23 is depressed by the pulley support surface 321 of the pulley bracket 32 to be resiliently deformed and resiliently returns to a free state in the wire guide groove 313 of the pulley body 31. In this state, the rigid retaining projection 22 and the resilient retaining projection 23 overlap the pulley body 31 of the pulley assembly 30a, which prevents the pulley body 31 from coming out of (coming off) the fit-in recessed portion 20a (fourth step).

As shown in FIG. 7(D), with the above described processes, the window regulator 1 in a subassembled state, before it is installed in a vehicle door, is completed. In the present embodiment, a portion of the pulley assembly 30a which corresponds to the wire winding area of the pulley body 31 (specifically, the area thereof on which the tensile load of the drive wire W2 is most imposed) is first fitted into the fit-in recessed portion 20a (second step), and thereafter, a portion of the pulley assembly 30a which corresponds to the wire non-winding area of the pulley body 31 is fitted into the fit-in recessed portion 20a (third step), and accordingly, even though the tensile load of the drive wire W2 is imposed on the pulley body 31, problems with the drive wire W2 wound around the pulley body 31 coming off, and with the pulley assembly 30a (the pulley body 31) being damaged can be reliably prevented from occurring.

The window regulator 1 in a subassembled state is incorporated in a vehicle door, to complete the assembly of the window regulator 1, by joining the plastic panel 10 to a door panel (inner panel) with joining bolts (not shown), which are inserted into the bolt insertion holes 332 of the nut members 33, and also joining a window glass (not shown) onto the slider base 13 and the slider base 14.

At this stage, since the process of producing the window regulator 1 in a subassembled state and the process of incorporating the window regulator 1 in a subassembled state in a vehicle door are performed in different production lines or different production factories, it is essential to provide a delivery process (carrying process) for the window regulator 1 in a subassembled state between the producing process and the incorporating process. In this delivery process (carrying process), sometimes the tensile load of the drive wire W2 is imposed on the pulley assembly 30a or sometimes an unexpected impact is exerted on the pulley body 31. In the present embodiment, since the rigid retaining projection 22 and the resilient retaining projection 23 directly hold the pulley body 31 of the pulley assembly 30a, the pulley body 31 can be reliably prevented from coming out of (coming off) the fit-in recessed portion 20a of the plastic panel 10 when delivering (when carrying) the window regulator 1 in a subassembled state. In addition, the drive wire W2 wound around the pulley body 31 can be reliably prevented from coming out of (coming off) the fit-in recessed portion 20a.

The advantageous effects obtained with the fit-in structure between the fit-in recessed portion 20a and the pulley assembly 30a that has been described in the present embodiment can also be obtained in exactly the same manner with the fit-in structures between the fit-in recessed portions 20b through 20d and the pulley assemblies 30b through 30d.

In the above illustrated embodiment, a so-called “double-guided” window regulator 1, in which the slider base 13 and the slider base 14 are supported on the guide rail 11 and on the guide rail 12 of the plastic panel 10 to be movable upwardly and downwardly, has been illustrated by way of example. However, the present invention can also be applied similarly to a single-guided type of window regulator, in which a single slider base is supported on a single guide rail to be movable upwardly and downwardly. In the case where the present invention is applied to a single-guided type of window regulator, an arrangement in which pulley assemblies are supported on upper and lower parts of a guide rail or an arrangement (a so-called lower-end drive) in which a pulley assembly is supported on an upper part of a guide rail while a wire drive mechanism is supported on a lower part of the guide rail is possible. In other words, the present invention is practical only when a pulley assembly is supported at at least one of upper and lower parts of a guide rail of a plastic panel.

Although the case where the rigid retaining projection (retaining projection/wire retaining projection/pulley retaining projection) 22 and the resilient retaining projection (retaining projection/resilient projection) 23 are each one in number has been illustrated by example in the above described embodiment, the rigid retaining projection 22 and the resilient retaining projection 23 can each be at least one in number; it is possible that one or each of these be at least two in number.

In the above illustrated embodiment, the case where the end of the rigid retaining projection 22 faces the top-surface flange 312 of the pulley body 31 and where the end of the resilient retaining projection 23 is positioned in the wire guide groove 313 of the pulley body 31 has been illustrated by example. However, an arrangement in which the rigid retaining projection 22 and the resilient retaining projection 23 are provided is not limited thereto; for instance, an arrangement in which both the rigid retaining projection 22 and the resilient retaining projection 23 are made to face the top-surface flange 312 of the pulley body 31 is also possible.

Although the end of the rigid retaining projection 22 extends to a position to face and overlap the top-surface flange 312 of the pulley body 31 in a plan view in the above described embodiment, the present invention is not limited to this embodiment; an arrangement in which the end of the rigid retaining projection 22 extends to a position proximate to a peripheral edge of the top-surface flange 312 of the pulley body 31 in a plan view is also possible.

Although the case where the rigid retaining projection 22 is used to serve as a pulley retaining projection and a wire retaining projection has been illustrated by example in the above described embodiment, it is possible to form, on each of the peripheral edges of the fit-in recessed portions 20a, 20b, 20c and 20d of the plastic panel 10, a rigid retaining projection as a pulley retaining projection and a rigid retaining projection as a wire retaining projection independently of each other.

### INDUSTRIAL APPLICABILITY

The window regulator according to the present invention is advantageously used as a window regulator which moves a window glass of, e.g., a vehicle.

### REFERENCE SIGN LIST

1 Window regulator
10 Plastic panel
11 12 Guide rail
13 14 Slider base
15 Drive drum
16 Motor unit
20a 20b 20c 20d Fit-in recessed portion
21 Through-hole
22 Rigid retaining projection (Retaining projection/Wire retaining projection/Pulley retaining projection)
23 Resilient retaining projection (Retaining projection/Resilient projection)
30a 30b 30c 30d Pulley assembly
31 Pulley body
311 Base-surface flange portion
312 Top-surface flange
313 Wire guide groove
314 Through-hole
32 Pulley bracket
321 Pulley support surface
322 Fit-in cylindrical portion
323 Raised wall portion
33 Nut member
331 Flange portion
332 Bolt insertion hole
W1 W2 Drive wire

1. A window regulator comprising:
a plastic panel with which a guide rail, extending in an upward and downward direction, is integrally formed;
a slider base which is supported to be movable upwardly and downwardly along said guide rail of said plastic panel and to which a window glass is fixed;
a wire which is fixed to said slider base; and
a pulley assembly which is supported by at least one of upper and lower parts of said guide rail of said plastic panel to be rotatable, said pulley assembly including a pulley body, around which said wire that is fixed to said slider base is wound,
wherein a fit-in recessed portion, into which said pulley assembly is fitted, is formed on said plastic panel, and
wherein a retaining projection is formed on said plastic panel, said retaining projection extending from a peripheral edge of said fit-in recessed portion toward a central part thereof and overlapping said pulley body of said pulley assembly, which is fitted into said fit-in recessed portion, in a plan view to prevent said pulley body from coming out of said fit-in recessed portion.

2. The window regulator according to claim 1, wherein said retaining projection comprises at least one rigid retaining projection and at least one resilient retaining projection, which is softer and more easily elastically-deformable than said rigid retaining projection, said rigid retaining projection and said resilient retaining projection being positioned to sandwich said pulley body of said pulley assembly, which is fitted into said fit-in recessed portion, in a plan view.

3. The window regulator according to claim 2, wherein said pulley body comprises a base-surface flange, a top-surface flange and a wire guide groove which is formed between said base-surface flange and said top-surface flange,
wherein an end of said rigid retaining projection faces said top-surface flange of said pulley body, and
wherein an end of said resilient retaining projection is positioned in said wire guide groove.

4. The window regulator according to claim 2, wherein said rigid retaining projection is positioned in a wire winding area of said pulley body in a plan view, and wherein said resilient retaining projection is positioned in a wire non-winding area of said pulley body in a plan view.

5. A method of assembling a window regulator subassembly, said method comprising:
a step of preparing a plastic panel, wherein a guide rail which extends in an upward and downward direction, a fit-in recessed portion which is positioned at at least one of upper and lower parts of said guide rail, and a pulley retaining projection which extends from a peripheral edge of said fit-in recessed portion toward a central part thereof in a plan view are formed integral with said plastic panel;
a step of making said guide rail hold a slider base, to which a window glass is fixed, in a manner to allow said slider base to freely move up and down; and
a step of fitting a pulley assembly into said fit-in recessed portion with a wire, which is fixed to said slider base, wound around a pulley body of said pulley assembly,
wherein, the step of fitting said pulley assembly performs, in the following order,
a first step of winding said wire around said pulley body of said pulley assembly less than one turn;
a second step of tilting an axis of said pulley assembly relative to an axis of said fit-in recessed portion and fitting a portion of said pulley assembly that corresponds to a wire winding area of said pulley body into said fit-in recessed portion, which is positioned underneath said pulley retaining projection, to thereby cause said pulley retaining projection to overlap said pulley body of said pulley assembly, which is fitted into said fit-in recessed portion in a plan view, to prevent said pulley body from coming out of said fit-in recessed portion; and
a third step of tilting said axis of said pulley assembly in a direction to make said axis of said pulley assembly coincide with said axis of the fit-in recessed portion, and fitting a portion of said pulley assembly which corresponds to a wire non-winding area of said pulley body into said fit-in recessed portion of said plastic panel.

6. The window regulator subassembly assembling method according to claim 5, wherein a wire retaining projection which extends from said peripheral edge of said fit-in recessed portion toward said central part thereof is formed on said plastic panel, and
wherein, in said second step, said axis of said pulley assembly is tilted relative to said axis of said fit-in recessed portion, and said portion of said pulley assembly which corresponds to said wire winding area of said pulley body is inserted into said fit-in recessed portion, which is positioned underneath said pulley retaining projection.

7. The window regulator subassembly assembling method according to claim 5, wherein a resilient projection which extends from said peripheral edge of said fit-in recessed portion toward said central part thereof is formed on said plastic panel, and
wherein, in said third step, said axis of said pulley assembly is tilted in a direction to coincide with said axis of said fit-in recessed portion, and said portion of said pulley assembly which corresponds to said wire non-winding area of said pulley body is fitted into said fit-in recessed portion while said resilient projection is being deformed.

8. The window regulator subassembly assembling method according to claim 6, wherein said wire retaining projection also serves as said pulley retaining projection, which extends from said peripheral edge of said fit-in recessed portion toward said central part thereof and overlaps said pulley body, of said pulley assembly fitted into said fit-in recessed portion, in a plan view to prevent said pulley body from coming out of said fit-in recessed portion.

9. A window regulator subassembly produced by performing:
a step of preparing a plastic panel, wherein a guide rail which extends in an upward and downward direction, a fit-in recessed portion which is positioned at at least one of upper and lower parts of said guide rail, and a pulley retaining projection which extends from a peripheral edge of said fit-in recessed portion toward a central part thereof in a plan view are formed integral with said plastic panel;
a step of making said guide rail hold a slider base, to which a window glass is fixed, in a manner to allow said slider base to move upwardly and downwardly; and
a step of fitting a pulley assembly into said fit-in recessed portion with a wire, which is fixed to said slider base, wound around a pulley body of said pulley assembly,
wherein the step of fitting said pulley assembly fit-in performs, in the following order,
a first step of winding said wire around said pulley body of said pulley assembly less than one turn;
a second step of tilting an axis of said pulley assembly relative to an axis of said fit-in recessed portion and fitting a portion of said pulley assembly that corresponds to a wire winding area of said pulley body into said fit-in recessed portion of said plastic panel;
a third step of tilting said axis of said pulley assembly in a direction to make said axis of said pulley assembly coincide with said axis of the fit-in recessed portion, and fitting a portion of said pulley assembly which corresponds to a wire non-winding area of said pulley body into said fit-in recessed portion of said plastic panel; and
a fourth step of making said pulley retaining projection overlap said pulley body of said pulley assembly, which is fitted into said fit-in recessed portion, to prevent said pulley body from coming out of said fit-in recessed portion.
